(19) United States
(12) Patent Application Publication
(10) Pub. No.: US 2021/0327193 A1
(43) Pub. Date: Oct. 21, 2021

(54) COIN PROCESSING APPARATUS

(71) Applicant: TOSHIBA TEC KABUSHIKI KAISHA, Tokyo (JP)

(72) Inventor: Tomonari KAKINO, Fuji Shizuoka (JP)

(21) Appl. No.: 17/127,160

(22) Filed: Dec. 18, 2020

(30) Foreign Application Priority Data
Apr. 20, 2020 (JP) 2020-074706

(51) Int. Cl. G07D 5/02; G06T 7/13; G06T 5/00; G07D 5/00

(52) U.S. Cl. CPC G07D 5/02; G06T 7/13; G06T 2207/20192; G07D 5/005; G06T 2207/20024; G06T 5/002

(57) ABSTRACT

A coin processing apparatus includes a processor to obtain an image of a deposited coin and specify a center of the deposited coin in the image. The processor then performs a first noise removal on a first image region of the image using a first process setting and a second noise removal on a second image region of the image using a second process setting that is different from the first process setting. A processed image of the deposited coin is generated including the first image region after the first noise removal and the second image region after the second noise removal. The processor identifies then the deposited coin using the processed image. The first image region and the second image region are defined based on a predetermined distance from the specified center of the coin.

### CROSS-REFERENCE TO RELATED APPLICATION

This application is based upon and claims the benefit of priority from Japanese Patent Application No. 2020-074706, filed on Apr. 20, 2020, the entire contents of which are incorporated herein by reference.

### FIELD

Embodiments described herein relate generally to a coin processing apparatus.

### BACKGROUND

A coin processing apparatus, such as an automated change return machine, must be able to accurately and reliably identify whether a deposited object is a usable coin. Some coin processing apparatuses identifies a deposited coin from a photographic image provided by an image sensor. In a technique for identifying a coin from an image, image processing such as filter processing with a noise filter is applied to the image provided by the image sensor. For example, if there is an unusable foreign currency coin having a size or the like similar to that of an acceptable coin, image processing for identifying particular characteristics of an acceptable coin is necessary in order to accurately determine whether the deposited coin is an acceptable coin.

However, generally, there are a variety of acceptable coin types with different sizes, patterns, materials, or the. As the image processing for identifying various coins, the image processing suitable identifying one specific coin type is not always suitable for other coin types. That is, an image obtained by an image sensor may not always be suitable for identifying acceptable coins of all possible types.

### BRIEF DESCRIPTION OF THE DRAWINGS

FIG. 1 illustrates a perspective view of an exterior of a coin processing apparatus according to an embodiment.

FIG. 2 illustrates a plan view of an example of an internal structure of a coin processing apparatus according to an embodiment.

FIG. 3 is a block diagram illustrating a configuration example of a coin processing apparatus according to an embodiment.

FIG. 4 is a flowchart of an operation example of coin processing including coin identification processing in a coin processing apparatus.

FIG. 5 is a diagram for explaining an example of a noise filter used for noise removal processing.

FIG. 6 is a diagram for explaining another example of a noise filter.

FIG. 7 depicts an example of a processed image obtained by applying a strong noise filter to an image obtained by photographing a one-yen coin.

FIG. 8 depicts an example of a processed image obtained by applying a weak noise filter to an image obtained by photographing a one-yen coin.

FIG. 9 depicts an example of a processed image obtained by applying a strong noise filter to an image obtained by photographing a five hundred-yen coin.

FIG. 10 depicts an example of a processed image obtained by applying a weak noise filter to an image obtained by photographing a five hundred-yen coin.

FIG. 11 depicts an example of a combined image obtained by combining the image illustrated in FIG. 9 and the image illustrated in FIG. 10.

FIG. 12 is a flowchart of a first processing example of preprocessing.

FIG. 13 is a flowchart of a second processing example of preprocessing.

### DETAILED DESCRIPTION

At least one embodiment provides, a coin processing apparatus that can obtain an image for reliably and accurately identifying coins of various types.

According to an embodiment, a coin processing apparatus includes a processor that is configured to obtain an image of a deposited coin and specify a center of the deposited coin in the image. The processor is configured to perform a first noise removal on a first image region of the image using a first process setting and a second noise removal on a second image region of the image using a second process setting that is different from the first process setting. A processed image of the deposited coin is generated including the first image region after the first noise removal and the second image region after the second noise removal. The processor is configured to identify the deposited coin based on the processed image. The first image region and the second image region are defined based on a predetermined distance from the specified center of the coin.

An embodiment is described below with reference to the drawings.

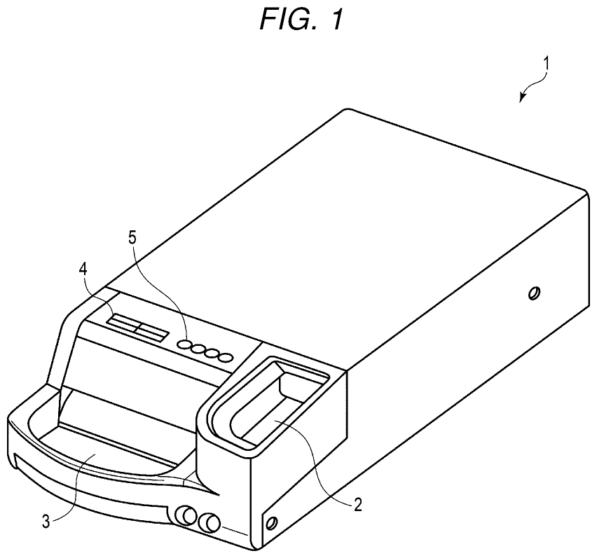

FIG. 1 illustrates an exterior view of a configuration example of a coin processing apparatus 1 according to an embodiment.

The coin processing apparatus 1 according to the embodiment is a coin identification apparatus that identifies the coins as deposited by a user by type. The coin processing apparatus 1 identifies the types of the coins to determine whether the deposited coins are acceptable coins. If the deposited coins are not acceptable for some reason, the coin processing apparatus 1 rejects the deposited coins. If the deposited coins are acceptable, the coin processing apparatus 1 sorts the coins by type and stores the coins in a storage location.

In the exterior illustrated in FIG. 1, the coin processing apparatus 1 includes a depositing port 2, a tray 3, an indicator 4, and an operation button 5.

The depositing port 2 is a receiving port for receiving a coin deposited by the user. The depositing port 2 may be referred to as a coin inlet. The depositing port 2 is formed to face upward. The depositing port 2 may be formed in a size for enabling a plurality of coins to be simultaneously deposited. The depositing port 2 may be formed in a size for depositing coins one by one.

The tray 3 receives a coin dispensed by the coin processing apparatus 1. The tray 3 is formed in a concave shape opened on an upper surface to enable the user to take out the coin.

The indicator 4 is a display device that displays an image for notifying various kinds of information to the user. The indicator 4 is configured by, for example, a liquid crystal display device, a seven-segment display device, or an LED (light emitting diode) display device.

The operation button 5 is configured with a plurality of buttons. The buttons functioning as the operation button 5 are set as keys for inputting specific instructions. The operation button 5 may be configured with a touch panel. The indicator 4 and the operation button 5 may be configured with a display device having a touch panel attached thereto.

The internal structure of the coin processing apparatus 1 according to the embodiment is described below.

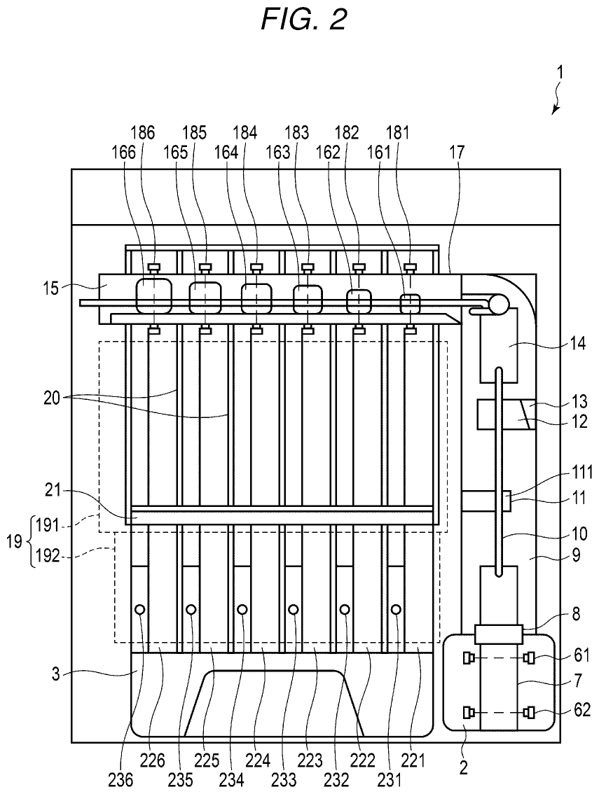

FIG. 2 illustrates a plan view of an example of an internal structure of the coin processing apparatus 1.

As illustrated in FIG. 2, the coin processing apparatus 1 includes a deposit sensor group 6 (deposit sensors 61 and 62), a conveying belt 7, a deposit roller 8, a guide plate 9, a conveying belt 10, a measurement sensor group 11 (111), a reject hole 12, a shutter 13, a conveying belt 14, a sorting plate 15, a sorting hole group 16 (sorting holes 161, 162, 163, 164, 165, and 166), a conveying belt 17, a storage sensor group 18 (storage sensors 181, 182, 183, 184, 185, and 186), a storage 19, partition plates 20, a separation roller 21, a conveying belt group 22 (conveying belts 221, 222, 223, 224, 225, and 226), and a discharge sensor group 23 (discharge sensors 231, 232, 233, 234, 235, and 236).

The deposit sensors 61 and 62 detect a coin deposited into the depositing port 2. The deposit sensors 61 and 62 are configured by, for example, a transmissive optical sensor.

The conveying belt 7 is disposed under the depositing port 2. The conveying belt 7 is set such that a coin deposited from the depositing port 2 drops to the upper surface of the conveying belt 7. The conveying belt 7 conveys the coin dropped to the upper surface in a depth direction of the coin processing apparatus 1 (an upward direction in FIG. 2).

The depositing roller 8 causes coins conveyed by the conveying belt 7 to pass one by one.

The guide plate 9 forms a conveyance path for conveying a coin. The conveying belt 10 conveys the coin on the upper surface of the guide plate 9 in a predetermined conveyance direction. The conveying belt 10 conveys, along the guide plate 9, the coin sandwiched between the conveying belt 10 and the upper surface of the guide plate 9. The upper surface of the guide plate 9 functions as a conveyance path for conveying the coin to the vicinity of the innermost part (the upward direction end portion in FIG. 2) of the coin processing apparatus 1. The conveying belt 10 conveys the coin at higher speed than the conveying belt 7. If multiple coins are simultaneously deposited into the depositing port 2, the conveying belt 10 continuously conveys the coins while keeping a fixed or larger interval.

The measurement sensor group 11 is configured from a plurality of measurement sensors. The measurement sensor group 11 includes an image sensor 111. The image sensor 111 photographs a coin. For example, the image sensor 111 is configured to photograph an image including the coin conveyed by the conveying belt 10. The measurement sensor group 11 only has to be a measurement sensor group configured from sensors that detect characteristics of a coin. For example, the measurement sensor group 11 may include, besides the image sensor 111, a sensor that measures characteristic values representing characteristics of the coin such as a material, thickness, a diameter, weight, and conductivity.

The reject hole 12 is a hole for rejecting a coin. The reject hole 12 is formed by, for example, opening a part of the guide plate 9 such that the coin drops. The position and the size of the reject hole 12 are decided such that the coin drops. The coin dropped from the reject hole 12 is stored in a reject tray disposed below the reject hole 12. The shutter 13 is provided in the reject hole 12. If the shutter 13 opens, the coin drops from the reject hole 12. If the shutter 13 closes, the coin is conveyed beyond the reject hole 12.

The conveying belt 14 further conveys the coin conveyed beyond the reject hole 12. The conveying belt 14 conveys the coin at lower speed than the conveying belt 10. Consequently, the conveying belt 14 slowly sends the coin into between the conveying belt 17 and the sorting plate 15.

The sorting plate 15 forms a conveyance path for conveying a coin. The conveying belt 17 conveys the coin on the upper surface of the sorting plate 15 in a predetermined conveyance direction (the left direction in FIG. 2). The upper surface of the sorting plate 15 functions as a conveyance path for conveying the coin in a predetermined conveyance direction of the coin processing apparatus 1. The conveying belt 17 conveys the coin, which is sent into between the conveying belt 17 and upper surface of the sorting plate 15 by the conveying belt 14, along the sorting plate 15 in a state in which the coin is sandwiched between the conveying belt 17 and the sorting plate 15.

The sorting hole group 16 (the sorting holes 161 to 166) is formed to open a part of the sorting plate 15. The sorting holes 161 to 166 are formed along the sorting plate 15 in the order of the sorting holes 161 to 166 in the conveyance direction of the coin by the conveying belt 17. The sorting holes 161 to 166 are configured to respectively have predetermined opening areas. In the example illustrated in FIG. 2, opening areas of the sorting holes 161 to 166 gradually increase in the order of arrangement in the conveyance direction. The opening areas of the respective sorting holes 161 to 166 are decided according to diameters of a plurality of types of coins set as storage targets by the coin processing apparatus 1.

For example, the coins set as the storage targets are coins of various denominations such as one yen, five yen, ten yen, fifty yen, one hundred yen, and five hundred yen. Opening areas of the respective sorting holes 161 to 166 are decided according to the diameters of the coins of one yen, fifty yen, five yen, one hundred yen, ten yen, and five hundred yen. As a specific example, the sorting hole 161 is configured to have an opening area through which the one-yen coin passes and coins of fifty yen, five yen, one hundred yen, ten yen, and five hundred yen do not pass. The sorting hole 162 is configured to have an opening area through which the coin of fifty yen passes and the coins of five yen, one hundred yen, ten yen, and five hundred yen do not pass. With the configuration, the one-yen coin is allowed to pass through the sorting hole 161 and the fifty-yen coin is allowed to pass through the sorting hole 162.

The storage sensor group 18 (the storage sensors 181 to 186) detects the coins passed through the sorting hole group 16 (the sorting holes 161 to 166). For example, the storage sensors 181 to 186 are respectively provided below the sorting plate 15. The storage sensors 181 to 186 detect the coins passing through the sorting holes 161 to 166 and dropping from the sorting plate 15. The storage sensors 181 to 186 are configured by, for example, a transmissive optical sensor.

The storage 19 stores the coins dropped passing through the sorting holes 161 to 166. The storage 19 includes a pooling section 191 and a standby section 192. The pooing section 191 stores a plurality of coins in an overlapping state. The standby section 192 stores a coin in a state in which the coin does not overlap other coins.

The partition plates 20 partition the internal space of the storage 19 into six storage spaces for individually storing the coins dropped passing through the sorting holes 161 to 166.

The separation roller 21 sends the coins stored in the pooling section 191 into the standby section 192 one by one.

The conveying belts 221 to 226 are disposed in the bottoms of the respective six storage spaces partitioned by the partition plates 20. The conveying belts 221 to 226 individually convey the coins stored in the storage spaces toward the tray 3.

The discharge sensor group 23 (231 to 236) detects a coin conveyed by the conveying belt group 22 and discharged from the storage 19. The discharge sensors 231 to 236 detect coins respectively conveyed by the conveying belts 221 to 226 and discharged from the storage 19. The discharge sensors 231 to 236 are configured by, for example, a reflective optical sensor.

The configuration of a control system of the coin processing apparatus 1 according to the embodiment is explained.

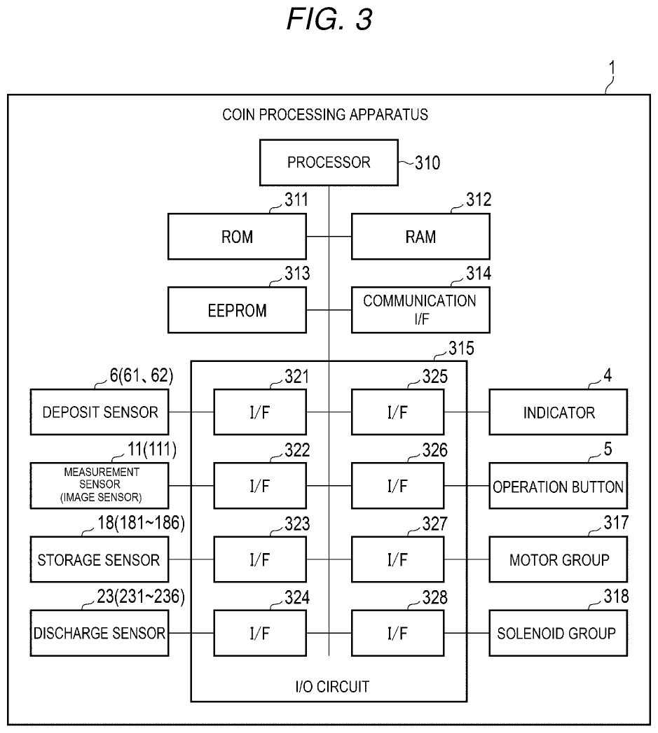

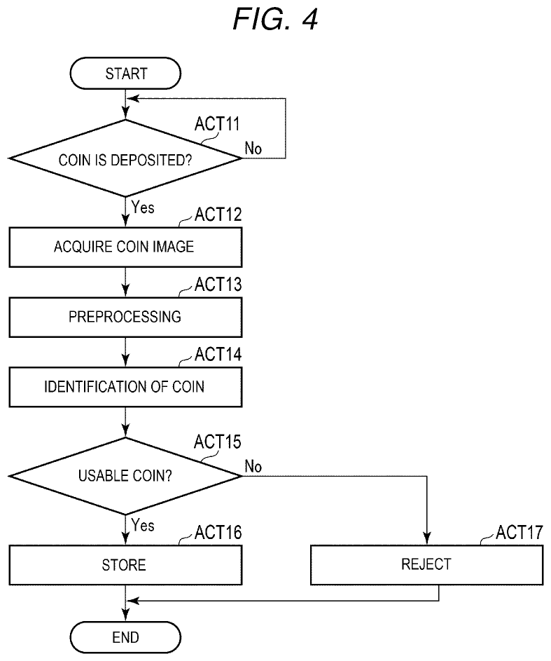

FIG. 3 is a block diagram illustrating a configuration example of a control system of the coin processing apparatus 1 according to the embodiment.

As illustrated in FIG. 3, the coin processing apparatus 1 includes the indicator 4, the operation button 5, the deposit sensor group 6, the measurement sensor group 11, the storage sensor group 18, the discharge sensor group 23, a processor 310, a ROM (read-only memory) 311, a RAM (random-access memory) 312, an EEPROM (registered trademark) (electrically erasable programmable read-only memory) 313, a communication interface 314, an I/O circuit 315, a motor group 317, and a solenoid group 318.

The processor 310 includes an arithmetic circuit that executes a program. The processor 310 is, for example, a CPU. The processor 310 executes a program stored by the ROM 311 or the EEPROM 313 to cause the coin processing apparatus 1 to operate. For example, the processor 310 executes a program for operation control stored by the ROM 311 or the EEPROM 313 to control the operation of units of the coin processing apparatus 1. The processor 310 executes a program for arithmetic operation stored by the ROM 311 or the EEPROM 313 to execute various kinds of arithmetic processing. As the arithmetic processing, the processor 310 executes coin identification processing including image processing.

The ROM 311 is nonvolatile memory. The ROM 311 stores programs to be executed by the processor 310. For example, the ROM 311 stores an OS (operating system) of the processor 310 and various programs operating on the OS. The ROM 311 stores, besides the programs, data such as setting values used to perform various kinds of processing.

The RAM 312 is volatile memory. The RAM 312 is used as a working memory that temporarily holds data. For example, the RAM 312 temporarily stores data used by the processor 310 to execute processing, a processing result, and the like.

The EEPROM 313 is a rewritable nonvolatile memory. The EEPROM 313 saves the programs to be executed by the processor 310, the setting data used for the various kinds of processing, and data indicating a processing result. For example, in the EEPROM 313, a management table for managing information indicating the processing result is provided.

The communication interface 314 is an interface for communicating with a host apparatus such as a POS terminal to which the coin processing apparatus 1 is connected. The processor 310 communicates with an external apparatus such as the POS terminal via the communication interface 314. In an embodiment, one or more of the processor 310, the ROM 311, the RAM 312, the EEPROM 313, and the communication interface 314, as part of the control system of the coin processing apparatus 1 can be configured as a coin processing apparatus.

The sensors in the sensor groups 6, 18, and 23 are connected to the processor 310 via an I/O circuit 315. Signals detected by the sensors of the sensor groups 6, 18, and 23 are supplied to the processor 310 via an interface (I/F) in the I/O circuit 315. In the example illustrated in FIG. 3, the deposit sensor group 6 (the deposit sensors 61 and 62) is connected to the processor 310 via an interface 321 of the I/O circuit 315. The storage sensor group 18 (the storage sensors 181 to 186) is connected to the processor 310 via an interface 322 of the I/O circuit 315. The discharge sensor group 23 (the discharge sensors 231 to 236) is connected to the processor 310 via an interface 323 of the I/O circuit 315.

The motor group 317 includes a plurality of motors. For example, the motor group 317 includes motors that rotate driving rollers for driving the conveying belts 7, 10, 14, 17, and 221 to 226. The motors of the motor group 317 are connected to the processor 310 and the like via an interface 327 in the I/O circuit 315. The processor 310 supplies control signals to the motors of the motor group 317 via the interface 327 to thereby control driving of the motors.

The solenoid group 318 includes solenoids for causing an opening and closing mechanism such as the shutter 13 to operate. The solenoids of the solenoid group 318 are connected to the processor 310 and the like via an interface 328 in the I/O circuit 315. The processor 310 supplies control signals to the solenoids of the solenoid group 318 via the interface 328 to thereby control driving of the solenoids.

The indicator 4 is connected to the processor 310 and the like via an interface 325 in the I/O circuit 315. The indicator 4 operates according to a control signal supplied from the processor 310 via the interface 325.

The operation button 5 is connected to the processor 310 and the like via an interface 326 in the I/O circuit 315. The operation button 5 supplies a signal indicating that the operation button 5 is pressed to the processor 310 via the interface 326.

Coin processing including coin identification processing performed by the coin processing apparatus 1 according to an embodiment is described below.

The processor 310 of the coin processing apparatus 1 executes a program stored in the ROM 311 or the EEPROM 313 to execute the coin processing including the coin identification processing. In the present embodiment, coin processing including coin identification processing based on an image photographed by the image sensor 111 of the measurement sensor group 11 is described.

First, the user deposits coins into the depositing port 2 (ACT 11). If the coins are deposited into the depositing port 2, the deposit sensors 61 and 62 detect the coins deposited into the depositing port 2. If the deposit sensors 61 and 62 detect the deposit of the coins, the processor 310 drives the conveying belt 7 and the deposit roller 8. The conveying belt 7 and the deposit roller 8 convey the deposited coins to the upper surface of the guide plate 9 one by one. The processor 310 drives the conveying belt 10 and conveys the coin on the guide plate 9.

In the measurement sensor group 11, the sensors acquire information indicating characteristics from the coin conveyed by the conveying belt 10. The sensors supply the information indicating the characteristics to the processor 310. In the coin identification processing according to the present embodiment, the image sensor 111 photographs the coin conveyed by the conveying belt 10. The image sensor 111 supplies an image obtained by photographing the coin (hereinafter referred to as coin image) to the processor 310. The processor 310 acquires the coin image from the image sensor 111 (ACT 12).

If acquiring the coin image from the image sensor 111, the processor 310 performs preprocessing for performing the coin identification processing to the coin image (ACT 13). The preprocessing is image processing for generating an image for identifying a type of the coin from the coin image (an image for identification). The preprocessing includes a plurality of kinds of image processing by different settings. For example, the preprocessing includes a plurality of kinds of filter processing by different settings. The preprocessing is explained below about two processing examples. The processor 310 may cause another processing device to carry out the preprocessing and acquire a processing result of the preprocessing from the other processing device.

The processor 310 executes the coin identification processing based on the image to which the preprocessing has been performed (the preprocessed image may be referred to as an image for identification) (ACT 14). As coin identification processing, the processor 310 determines the coin type of the coin in the preprocessed image and then determines whether the coin is an acceptable coin type (a “usable coin” such as a coin that can be stored in the storage by the apparatus). For example, the processor 310 determines the usable coin types by assuming that any coin of the country in which the apparatus is located is an acceptable coin and any coins other than those coins of the location country (e.g., coins from other countries (foreign coins), coins for particular games (game tokens), and the like) are unacceptable coins to be rejected.

A method of identifying a type of a coin is not limited to any specific method. For example, the processor 310 may determine a coin type according to pattern matching by comparison, collation, and the like of the image for identification obtained by the preprocessing and a template of coin types. The processor 310 may acquire a binary image for identification in the preprocessing and identify a coin type according to a pixel distribution obtained by counting black pixels (or white pixels) at each of distances from the center of a coin.

The processor 310 controls conveyance of the coin based on an identification result by the coin identification processing. If the coin is an unusable coin (NO in ACT 15), the processor 310 performs control to reject the coin (ACT 17). For example, if rejecting the coin, the processor 310 opens the shutter 13 to thereby drop the coin through the reject hole 12.

If the coin is a usable coin (YES in ACT 15), the processor 310 then identifies a type of the coin based on a result of the identification processing. The processor 310 causes the coin to be stored in a storage location in which the coin of the identified type is stored (ACT 16). For example, the processor 310 closes the shutter 13 to thereby convey the coin to the conveying belt 14. The conveying belt 14 sends the coin between the conveying belt 17 and the sorting plate 15. The conveying belt 17 conveys the coin along the sorting plate 15 while the coin is sandwiched between the conveying belt 17 and the sorting plate 15. The coin conveyed along the sorting plate 15 is sent to the storage 19 from one of the sorting holes 161 to 166 provided according to acceptable types of coins.

The preprocessing in the coin processing of the coin processing apparatus 1 is now further explained.

The following explanation is based on the premise that the acceptable coin types each have different sizes (diameters). It is also assumed that various coins have different patterns formed on the surfaces of the coins and types the coins are identified from images photographed by the image sensor 111. It is also assumed that materials and the like of the acceptable coins can be different depending on the types, but in any event the acceptable coins have specific characteristics for each of the different acceptable coin types. The coin processing apparatus 1 according to the embodiment carries out different kinds of image processing as the preprocessing according to characteristics of the various deposited coins/objects. The preprocessing is processing for generating an image for identification that makes it easier to identify various coins from an image provided by the image sensor 111.

For example, among the coins in Japan, since the one-yen coin is made of aluminum, the surface of the one-yen coin is easily scratched. Therefore, if strong noise removal processing (NR) for removing scratches on the surface is carried out for an image obtained by photographing the one-yen coin, an image to be more easily identified as the one-yen coin can be obtained. Conversely, if the noise removal processing is weakened for the image obtained by photographing the one-yen coin, images of scratches and the like will often remain in the processed image. Therefore, t the one-yen coin image may be less easily identified due to the presence of the surface scratches or other defects remaining after image processing with lower level of noise reduction/filtering.

As the noise removal processing, for example, there is filter processing performed using a noise filter. Strength of the noise filter can be adjusted or varied. The strength of the noise filter can be defined as the size of a range to be removed as an isolated point. That is, as the noise filter becomes stronger, the noise removal processing removes a larger isolated point as the noise. The noise removal processing may be referred to as noise reduction processing and need not remove all noise from a target image.

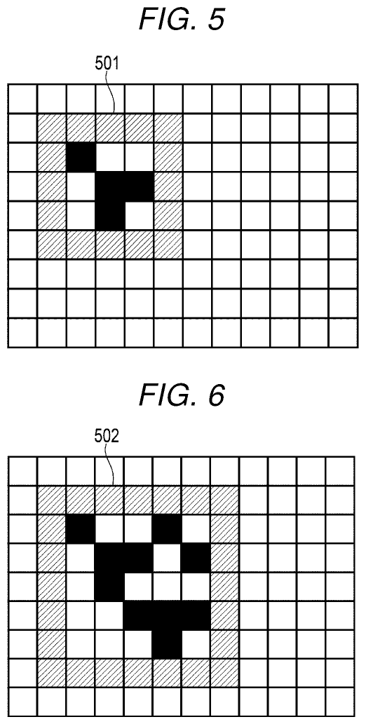

FIGS. 5 and 6 are diagrams for explaining aspects related to a strength of a noise filter used for noise removal processing.

In the following description, noise removal processing for removing noise of black points (black pixels) in a binary image formed by white pixels and black pixels is assumed. As illustrated in FIGS. 5 and 6, if any black pixels in pixel groups surrounded entirely by white pixels of the set frames 501 and 502, the noise filter converts all pixels inside the frames 501 and 502 into white pixels. The strength of the noise filter is determined by the size of the applied frame. As the frame gets larger, pixels over a wider range (frame size) are converted into white. Therefore, a larger black pixel group can be removed in the filtering.

For example, in an example illustrated in FIG. 5, the frame 501 functioning as a noise filter is formed by a 5×5 pixel frame. In this case, since all pixels forming the 5×5 frame 501 are white, the entire 3×3 pixel group present inside the frame 501 is converted into white pixels.

In an example illustrated in FIG. 6, the frame 502 functioning as a noise filter is formed by a 7×7 pixel frame. In this case, since all pixels forming the 7×7 frame 502 are white, an entire 5×5 pixel group inside the frame 502 is converted into white.

That is, the frame 501 illustrated in FIG. 5 removes black points having a 3×3 pixel group size at most. However, the frame 502 illustrated in FIG. 6 removes black points having up to a 5×5 pixel group size. The noise filter illustrated in FIG. 6 can thus remove a larger black pixel group than the noise filter illustrated in FIG. 5. This means that the noise filter illustrated in FIG. 6 is stronger than the noise filter illustrated in FIG. 5. In this way, as the frame functioning as a noise filter is made larger, the noise filter becomes a stronger noise filter.

An example of noise removal processing (filter processing) performed by using two types of noise filters is described.

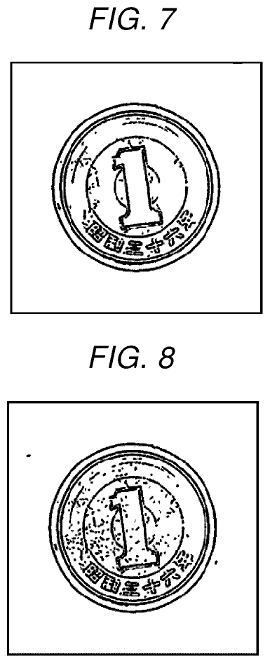

FIG. 7 is a diagram illustrating an example of a processed image obtained through the noise removal processing, using a strong noise filter, on an image obtained by photographing a one-yen coin. FIG. 8 is a diagram illustrating an example of a processed image obtained through the noise removal processing, using a weak noise filter, on the image obtained by photographing the one-yen coin.

In the image illustrated in FIG. 7, compared with the image illustrated in FIG. 8, relatively large amounts of noise in the image (assumed to be caused by scratches and the like on the surface of the one-yen coin) can be removed and a pattern formed on the surface of the coin clearly appears. That is, the processed image can be easily identified if the noise removal processing (the filter processing) is performed using the strong noise filter.

A characteristic pattern is formed near the outer circumference edge of the five hundred-yen coin. The noise removal processing is preferably performed using a weak noise filter so as to not erase this characteristic pattern when processing an image obtained by photographing a five hundred-yen coin. Keeping this characteristic pattern in the image to be identified permits easier identification of a coin as a five hundred-yen coin. Conversely, if the noise removal processing is then it is possible part of the characteristic pattern would be removed/erased from the image to be identified, making it more difficult to accurately identify a five hundred-yen coin from the processed image.

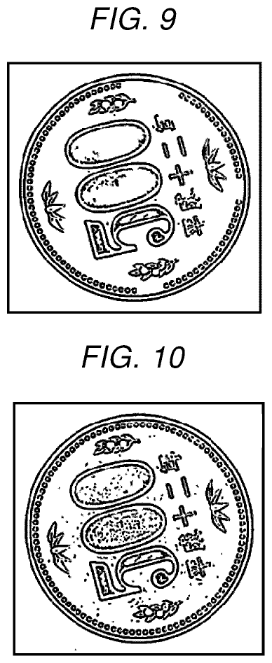

FIG. 9 is a diagram illustrating an example of a processed image obtained using a strong noise filter on an image obtained by photographing a five hundred-yen coin. FIG. 10 is a diagram illustrating an example of a processed image obtained using a weak noise filter (that is, a noise filter weaker than the noise filter used for FIG. 9) on the image obtained by photographing a five hundred-yen coin.

In the image illustrated in FIG. 9, it can be seen that a part of the pattern present at the outer circumference of the five hundred-yen coin disappears. On the other hand, in the image illustrated in FIG. 10, the pattern present at the outer circumference of the five hundred-yen coin remains without disappeared portions. That is, the image illustrated in FIG. 9 is an image in which the pattern present at the outer circumference of the five hundred-yen coin is less easily recognized. Therefore, an image to be more easily identified can obtained if the noise removal processing is performed using the weak noise filter for at least an image region near the outer circumference of the five hundred-yen coin.

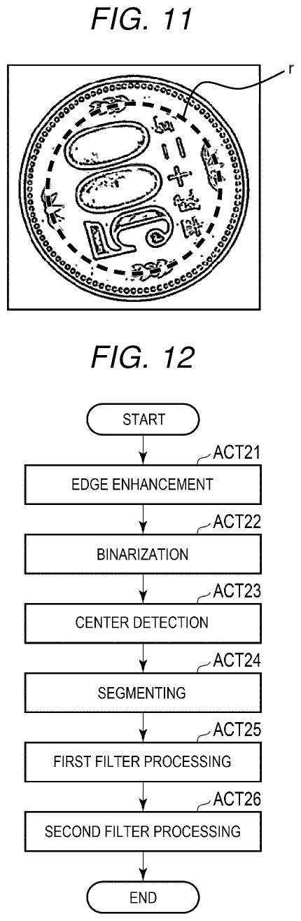

The five hundred-yen coin has a larger diameter than the one-yen coin. If the centers of the one-yen coin and the five hundred-yen coin are aligned with each other, the pattern present at the outer circumference of the five hundred-yen coin will be beyond the outer edge position of the one-yen coin. The radius of the one-yen coin is represented as “r” (see FIG. 11). If the strong noise removal processing (NR strong) is performed on a photographed image of the coin in a range only inside the radius “r” from the center of the coin, the one-yen coin is still easily identified. If the weak noise removal processing (NR weak) is performed only on a range beyond the radius “r” from the center of the coin, then outer edge characteristic pattern of five hundred-coin is still easily identified.

The preprocessing is image processing for generating an image for identification for identifying a type of a coin from an image (a coin image) obtained by photographing a coin, a type of which is initially unknown. Therefore, the preprocessing includes the strong noise removal processing in a range of the radius “r” from the center of the coin and the weak noise removal processing in a range exceeding the radius “r” from the center of the coin. With such preprocessing, an image (an image for identification) in which the one-yen coin and the five hundred-yen coin are easily identified is obtained.

FIG. 11 is a diagram illustrating an example of a processed image in which the inside of a range of the radius “r” indicated by a dotted line is the image illustrated in FIG. 9 and the outside of the range of the radius “r” is the image illustrated in FIG. 10.

The image illustrated in FIG. 11 is an image obtained if the weak noise removal processing is performed outside of the range of the radius “r” and the strong noise removal processing is performed inside of the range of the radius “r” as the preprocessing. In the image illustrated in FIG. 11, the characteristic pattern present at the outer circumference of the five hundred-yen coin remains and the pattern present within the range of the radius “r” does not disappear. Therefore, the image is considered to be an image easily recognized as the five hundred-yen coin. Since the radius “r” is the radius of the one-yen coin, the strong noise removal processing can be performed on, over an entire image region of the one-yen coin. Therefore, with the preprocessing in which the weak noise removal processing is performed outside the radius “r” and the weak noise removal processing is performed inside the radius “r”, a processed image in which either of the one-yen coin and the five hundred-yen coin are easily identifiable can be obtained.

A first processing example of the preprocessing in the coin processing apparatus 1 according to the embodiment is described.

FIG. 12 is a flowchart of the first processing example of the preprocessing in the coin processing apparatus 1 according to the embodiment.

First, as the preprocessing, the processor 310 acquires a coin image obtained by the image sensor 111 photographing a coin. The coin image is held, for example, in the RAM 312. The processor 310 performs, on the coin image acquired from the image sensor 111, edge enhancement processing as image processing for enhancing an edge such as an outer contour of the coin (ACT 21). The edge enhancement processing only has to be processing for making it easy to detect the outer contour of the coin from the image photographed by the image sensor 111.

After carrying out the edge enhancement processing on the image acquired from the image sensor 111, the processor 310 executes binarization processing on the image to which the edge enhancement processing has been applied (ACT 22). The binarization processing only has to be processing for binarizing pixels based on a threshold at which a pattern present on the surface of the coin appears in the image photographed by the image sensor 111. Upon obtaining a binary image (a binarized image), the processor 310 performs center detection processing for detecting the center position of the coin in the binarized image (ACT 23).

Upon detecting the center position of the coin, the processor 310 segments the image into a predetermined region starting from the detected center position of the coin (ACT 24). In this context, the predetermined region is a region including the largest coin among the acceptable coin types. For example, the predetermined region may be set as a rectangular region centering on the detected center position of the coin. The image in the predetermined region is a processing target image, which is a target for subsequent first filter processing and second filter processing.

Upon obtaining the segmented processing target image segmented based on the center position of the coin, the processor 310 executes the first filter processing on the processing target image (ACT 25). In this first processing example, the first filter processing is filter processing applied to the entire processing target image using a first setting value. The first filter processing can be processing for making it easier to detect characteristics present near the outer circumference of a large coin from among usable coin types. For example, if various coins of Japanese yen denomination are to be identified, the first filter processing only has to be weak noise removal processing at which the pattern present at the outer circumference of a five hundred-yen coin is not lost, as described above.

After executing the first filter processing, the processor 310 then executes the second filter processing on the image portion within a predetermined range from the center of the coin in the segmented processing target image (ACT 26). The second filter processing is filter processing using a second setting value different from the first setting value of the first filter processing. The second filter processing can be image processing for making it easier to detect a pattern and the like within some predetermined distance from the center of the coin. The predetermined distance is set in this example to a value not including a region of an outer circumference portion of a large coin among the usable coin types. Thus, the second filter processing can be applied just to an image portion within the predetermined distance from the center of the coin while leaving characteristics (the image processed by the first filter processing) present near the outer circumference of a larger coin among the usable coins. For example, if identification targets are various coins of Japanese yen denominations, the second filter processing can be noise removal processing performed using a strong noise filter that can remove noise due to scratches and the like present within the size range of the one-yen coin.

As described above, in the preprocessing of the first processing example, an image to be identified is obtained by applying the first filter processing and then the second filter processing to the coin image. Thus, with the preprocessing of the first processing example, it is possible to generate an image for identification by applying the first filter processing to a range exceeding the predetermined range from the center and then applying the second filter processing within the predetermined range.

A second processing example of the preprocessing in the coin processing apparatus 1 according to the embodiment is described.

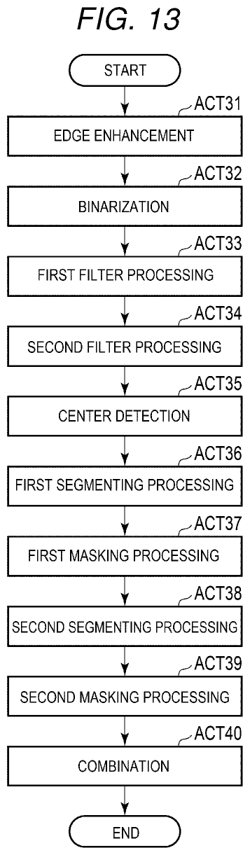

FIG. 13 is a flowchart of the second processing example of the preprocessing in the coin processing apparatus 1 according to the embodiment.

The processor 310 performs, on a coin image acquired from the image sensor 111, edge enhancement processing serving as image processing for enhancing an edge such as an outer contour of a coin (ACT 31). The edge enhancement processing is processing for making it easy to detect an outer contour of a coin from an image photographed by the image sensor 111. After carrying out the edge enhancement processing on the image acquired from the image sensor 111, the processor 310 executes binarization processing on the edge-enhanced image (ACT 32). The binarization processing is processing for binarizing pixels based on a threshold at which a pattern present on the surface of the coin appears in the image photographed by the image sensor 111.

Upon acquiring a binarized image, the processor 310 duplicates the binarized image and holds two copies of the binarized image in the RAM 312. The processor 310 performs the first filter processing on one copy of the binarized image (ACT 33) and then performs the second filter processing on the other copy of the binarized image (ACT 34).

The first filter processing is filter processing using the first setting value. The first filter processing can be processing for making it easy to detect characteristics present near the outer circumference of a large coin among the usable coin types. For example, the first filter processing is noise removal processing using a weak noise filter with which the pattern present at the outer circumference of a five hundred-yen coin is not lost as described above.

The second filter processing is filter processing using a second setting value different from the first setting value of the first filter processing. The second filter processing can be image processing for making it easy to detect a pattern or the like within a predetermined distance from the center of the coin. The predetermined distance is set to a value not including the region of the outer circumferential portion of a large coin among the usable coin types. For example, the second filter processing is noise removal processing using a strong noise filter for removing noise due to scratches and the like within the range of the one-yen coin.

The processor 310 executes center detection processing for detecting the center position of the coin from the copy of the binarized image on which the second filter processing has been performed (ACT 35). In the second processing example, it is assumed that the second processing example is noise removal processing (filter processing) by the strong noise filter. In the copy of the binarized image on which the noise removal processing using the strong noise filter has been performed, since the outer contour and the like of the coin is clarified, it is easy to identify an image region of the coin. Accordingly, in the second processing example illustrated in FIG. 13, the center position of the coin is detected from the copy of the binarized image to which the second filter processing has been applied. However, in other examples, the processor 310 may execute center detection processing for detecting the center position of the coin from the copy of the binarized image to which only the first filter processing has been applied. That is, processor 310 may execute center detection processing for detecting the center position of the coin from the copy of the binarized image to which either of the first or second filter processing has been applied.

After detecting the center position of the coin, the processor 310 segments the image into a predetermine region starting from the detected center position of the coin in the copy of binarized image to which the first filter processing was applied (ACT 36). As in the first processing example, the predetermined region is a region in which the largest coin among the usable coins is included. For example, the predetermined region may be set as a rectangular region centering on the detected center position.

After segmenting the image into the predetermined region, the processor 310 performs a first masking processing on the segmented binarized image segmented (ACT 37). The first masking processing is masking processing by a first mask that allows an image in a range exceeding a predetermined distance from the center of the coin to pass. Thus, the copy of the binarized image to which the first filter processing (the filter processing by the weak noise filter) was applied is converted by the first masking processing into an image including information only in the range exceeding the predetermined distance from the center of the coin.

The processor 310 also segments the copy of the binarized image to which the second filter processing was applied based on the detected center position of the coin (ACT 38). After segmenting the copy of the binarized image to which the second filter processing was applied into a predetermined region from center position of the coin, the processor 310 performs a second masking processing (ACT 39). The second masking processing is masking processing by a second mask that allows an image within a predetermined distance from the center of the coin to pass. Thus, the copy of the binarized image to which the second filter processing (the filter processing by the strong noise filter) was performed is converted by the second masking process into an image with information only within the predetermined distance from the center of the coin.

Once the first masking processing and the second masking processing are completed, the processor 310 combines the two images (ACT 40). The processor 310 generates a combined image by combining the processed separate copies of the binarized image such that the center positions coincide.

The processor 310 generates a combined image in which a region within the predetermined distance from the center of the coin is an image portion on which the second filter processing was performed and a region outside the predetermined distance is an image portion on which the first filter processing was performed. The combined image obtained by such processing is an image for identification obtained by the preprocessing of the second processing example.

The first filter processing (ACT 33) and the second filter processing (ACT 34) may be carried out independently from each other. For example, the first filter processing (ACT 33) and the second filter processing (ACT 34) may be carried out in parallel. Similarly, in some examples, the first filter processing may be carried out after the second filter processing is carried out.

The processing in ACT 36 and ACT 37 and the processing in ACT 38 and ACT 39 may be carried out independently from each other. For example, the processing in ACTS 36 and 37 and the processing in ACTS 38 and 39 may be carried out in parallel. In other examples, the processing in ACTS 36 and 37 may be carried out after the processing in ACTS 38 and 39.

As described above, in the preprocessing of the second processing example, the image obtained by combining the image portions obtained by performing the first filter processing to the coin image including the coin and the image obtained by performing the second filter processing to the coin image including the coin is generated. The combined image is an image to which the portion outside the predetermined range from the center is processed by the first filter processing and the portion inside the predetermined range is processed by the second filter processing. Consequently, with the preprocessing of the second processing example, it is possible to generate an image for identification in which the first filter processing is applied to the range exceeding the predetermined range from the center and the second filter processing is applied to the range within the predetermined range.

With the coin processing apparatus according to the embodiments described above, by performing a plurality of kinds of image processing corresponding to types of coins to an image obtained by photographing a coin, it is possible to obtain an image in which a coin type can be more easily identified. By performing image processing corresponding to a usable coin type, it is possible to more accurately identify an unusable coin such as a foreign currency coin. As a result, even if a foreign currency coin similar in many characteristics to a usable coin is deposited by mistake, the coin processing apparatus according to the embodiment can more surely exclude the foreign currency coin.

For example, the coin processing apparatus according to the embodiment can perform the preprocessing for performing the first filter processing by the strong noise filter in the range of the radius “r” of the one-yen coin and performing the second filter processing by the weak noise filter in the range exceeding the radius “r”. In an image for identification generated by such preprocessing, noise due to scratches and the like can be removed within the range of the radius “r” of the one-yen coin and the pattern in the outer circumference of the five hundred-yen coin can be erased in the range exceeding the radius “r”. As a result, the coin processing apparatus according to the embodiment can accurately identify the one-yen coin and the five hundred-yen coin and can highly accurately determine that even a foreign currency coin similar to the five hundred-yen coin is unusable.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A coin processing apparatus, comprising:
a processor configured to:
obtain an image of a deposited coin;
specify a center of the deposited coin in the image;
perform a first noise removal on a first image region of the image using a first process setting;
perform a second noise removal on a second image region of the image using a second process setting different from the first process setting; and
generate a processed image of the deposited coin including the first image region after the first noise removal and the second image region after the second noise removal;
identify the deposited coin based on the processed image, wherein
the first image region and the second image region are defined based on a predetermined distance from the specified center of the deposited coin.

2. The coin processing apparatus according to claim 1, further comprising:
an image sensor configured to acquire the image of the deposited coin.

3. The coin processing apparatus according to claim 1, further comprising:
an input/output circuit configured to receive the image of the deposited coin from an image sensor.

4. The coin processing apparatus according to claim 1, further comprising:
a coin deposit inlet configured to receive a deposit of coins;
a coin reject outlet configured to receive deposited coins that cannot be identified as an acceptable coin type.

5. The coin processing apparatus according to claim 1, wherein
the first image region surrounds the second image region, and
the first noise removal is weaker than the second noise removal.

6. The coin processing apparatus according to claim 1, wherein the processor is further configured to:
perform an edge enhancement process on the image of the deposited coin before specifying the center of the deposited coin in the image, and
perform a binarization process on the image of the deposited coin before specifying the center of the deposited coin in the image.

7. The coin processing apparatus according to claim 1, wherein the processor is further configured to:
duplicate the image of the deposited coin to provide two copies of the image for processing.

8. The coin processing apparatus according to claim 7, wherein
the first noise removal on the first image region of the image is performed by processing a first copy of the image, and
the second noise removal on the second image region of the image is performed by processing a second copy of the image.

9. The coin processing apparatus according to claim 8, wherein the processed image of the deposited coin is generated by combining the first image region from the first copy and the second image region from the second copy.

10. A coin processing apparatus, comprising:
an interface configured to receive an image of a coin; and
a processor configured to:
perform a first filtering operation with respect to a first image region of the received image to reduce noise in the first image region, the first image region including a region outside of a circular region of a predetermined diameter, the circular region having a center coinciding with a center of the coin in the image;
perform a second filtering operation with respect to a second image region of the received image to reduce noise in the second image region, the second image region being inside the circular region, a noise reduction strength of the first filtering operation being different from the noise reduction strength of the second filtering operation; and
determine a coin type for the coin in the image based on a processed image of the coin obtained through the first and second filtering operations.

11. The coin processing apparatus according to claim 10, wherein the first image region overlaps the second image region.

12. The coin processing apparatus according to claim 10, wherein the noise reduction strength of the first filtering operation is less than the noise reduction strength of the second filtering operation.

13. The coin processing apparatus according to claim 10, wherein the first image region does not overlap the second image region.

14. The coin processing apparatus according to claim 10, wherein the processor is further configured to perform a binarization of the image of the coin.

15. The coin processing apparatus according to claim 10, wherein the predetermined diameter is a diameter of a coin of a predetermined type.

16. A coin processing apparatus, comprising:
a coin inlet configured to receive coins;
a sensor configured to capture an image of a coin received by the coin inlet;
a coin storage location configured to store coins of a predetermined type;
a coin conveyor configured to convey the coins received via the coin inlet to the coin storage location; and
a processor configured to:
perform a first filtering operation with respect to a first image region of the captured image to reduce noise in the first image region, the first image region including a region outside of a circular region of a predetermined diameter, the circular region having a center coinciding with a center of the coin in the captured image;
perform a second filtering operation with respect to a second image region of the captured image to reduce noise in the second image region, the second image region being inside the circular region, a noise reduction strength of the first filtering operation being different from the noise reduction strength of the second filtering operation; and
determine a coin type for the coin in the captured image based on a processed image of the coin obtained through the first and second filtering operations.

17. The coin processing apparatus according to claim 16, wherein the first image region overlaps the second image region.

18. The coin processing apparatus according to claim 16, wherein the noise reduction strength of the first filtering operation is less than the noise reduction strength of the second filtering operation.

19. The coin processing apparatus according to claim 16, wherein the first image region does not overlap the second image region.

20. The coin processing apparatus according to claim 16, wherein the processor is further configured to:
duplicate the captured image of the deposited coin to provide two copies of the captured image for processing, wherein
the first filtering operation on the first image region of the captured image is performed by processing a first copy of the captured image,
the second filtering operation on the second image region of the captured image is performed by processing a second copy of the captured image, and
the processed image of the coin is generated by combining the first image region from the first copy and the second image region from the second copy.
